(19) United States
(12) Patent Application Publication
(10) Pub. No.: US 2003/0163708 A1
(43) Pub. Date: Aug. 28, 2003

(54) Method and system for detecting and eliminating fraud

(76) Inventor: James Tang, Houston, TX (US)

Correspondence Address: BAKER & BOTTS, 30 ROCKEFELLER PLAZA, NEW YORK, NY, 10112

(21) Appl. No.: 10/200,101

(22) Filed: Jul. 19, 2002

Related U.S. Application Data
(60) Provisional application No. 60/360,315, filed on Feb. 27, 2002.

(51) Int. Cl. H04K 1/00

(52) U.S. Cl. 713/185

(57) ABSTRACT

Disclosed is a method and system for detecting and eliminating fraud by verifying the identity of a requesting individual desiring to engage in a transaction as well as a method for authenticating individuals to become initially registered with the verification entity as a trusted individuals. The verification method includes receiving a token uniquely identifying a trusted individual that the requesting individual purports to be, as well as a verification image depicting the requesting user performing a secret gesture. The verification image is compared with previously stored data regarding the trusted individual, including a previously stored image of the trusted individual to verify if the requesting individual resembles the trusted individual and whether the requesting individual depicted in the verification image is performing the secret gesture associated with the trusted individual. The authentication method includes receiving an image of an individual seeking to be registered as a trusted individual and conducting an investigation into the individual seeking registration by identifying persons who would be likely to recognize the individual seeking registration and asking them to identify the individual depicted in the received image. If one or more persons recognize the individual seeking registration, the individual is authenticated and is registered as a trusted individual.

### RELATED APPLICATION

This application claims priority from provisional U.S. application No. 60/360,315, filed Feb. 27, 2002, which is incorporated herein by reference.

### BACKGROUND OF INVENTION

In order for business enterprises to prosper as commercial markets expand, organizations and businesses are under constant pressure to innovate to transact with persons in ways other than traditional face-to-face contact. For example, many industries benefit from an ability to transact with persons via telephone, facsimile, computer networks such as the Internet, or other electronic media. However, with this progression away from traditional face-to-face contact, there arises opportunities and associated temptations for individuals to perpetrate fraud. For example, individuals may be tempted to access information that they are not authorized to access, engage in transactions that they are not authorized to engage in, repudiate transactions that they are responsible for, or perform other fraudulent acts. These opportunities for fraud arise primarily because in electronic transactions there is no visual record of the individual performing the fraudulent acts. Thus, there is little deterrent to attempting these fraudulent acts, since, even if they are ultimately unsuccessful, it is unlikely that the perpetrator will be identified or caught.

### SUMMARY OF INVENTION

The present invention in one aspect is a method for verifying the identity of an individual requesting a transaction, known as a requesting individual, to prevent or detect fraud.

In one exemplary embodiment, the method includes receiving a token that uniquely identifies a trusted individual (for whom data has previously been received) that the requesting individual purports to be, and receiving a verification image depicting the requesting individual performing a secret gesture. The verification image may include information indicating when and/or where the image was acquired. A database containing at least one previously stored image of the trusted individual that the requesting individual purports to be as well as data pertaining to the secret gesture of the trusted individual is accessed. The requesting individual is verified if the requesting individual depicted in the verification image is performing the secret gesture associated with the trusted user and if the physical appearance of the requesting individual resembles that of the individual depicted in the previously stored image of the trusted individual.

In another exemplary embodiment, the database of the previous embodiment includes at least two previously stored images of the trusted individual, a first image depicting the trusted individual performing his/her associated secret gesture and a second image depicting the trusted individual while he/she is not performing the secret gesture. In this embodiment, the data pertaining to the secret gesture of the trusted individual stored in the database is embodied in the image of the trusted individual performing the secret gesture associated with the trusted individual. In one variant of this embodiment, the identity of the requesting individual is verified if the individual depicted in the verification image is performing the same secret gesture as the trusted individual is performing in the first previously stored image and if the physical appearance of the individual depicted in the verification image appears to be the same as that of the person depicted in one or more of the previously stored images of the trusted individual. In another variant of this embodiment where the requesting individual is in direct view of a local attendant (e.g., in a face to face transaction), the identity of the requesting individual is verified if the individual depicted in the verification image is performing the same secret gesture that the trusted individual is performing in the first previously stored image and if the requesting individual appears to the local attendant to be the person depicted in one or more of the previously stored images of the trusted individual.

In another exemplary embodiment, the verification image of the requesting individual is stored in a database. The stored image may be used to subsequently identify the requesting individual if the requesting individual attempts or completes a fraudulent transaction or may be used during subsequent verification as the previously stored image of the trusted individual.

In yet another exemplary embodiment, information about the proposed transaction is received along with the verification image. This information may be stored and used during subsequent investigation of an attempted or completed fraudulent transaction.

In another exemplary embodiment, the trusted status of the individual associated with the received token is suspended if the requesting individual is not verified.

In another exemplary embodiment, the requesting individual is required to provide a token that uniquely identifies the trusted individual that the requesting individual purports to be. The requesting individual is prompted to pose for a verification image of himself or herself while performing the secret gesture associated with the trusted individual he/she purports to be. The verification image is then acquired and transmitted, along with the received token, to a remote verification facility. A verification officer at the remote verification facility uses the token to retrieve from a database an image of a corresponding trusted individual performing his or her secret gesture and compares the retrieved image with the verification image. The verification officer then sends a verification decision from the remote verification facility, indicating whether or not the requesting individual is the trusted individual he/she purports to be.

In a variant of the preceding exemplary embodiment, the verification image once acquired is first displayed to the requesting individual for his/her approval before the image is transmitted to the remote facility. If the image is not approved by the requesting individual, the steps of prompting the requesting individual to pose for the verification image of himself or herself, acquiring and displaying the verification image to the requesting individual are repeated.

Another aspect of the present invention is a system for verifying the identity of a requesting individual. The system includes a token receiver at a verification facility, for receiving a token that uniquely identifies a trusted individual (for whom data has previously been received) that the requesting individual purports to be. The system also includes an image receiver at the verification facility for receiving a verification image depicting the requesting individual performing a secret gesture. Furthermore, the system includes a database containing a data record associated with the received token, the data record including at least one previously stored image depicting the trusted individual corresponding to the received token, including data pertaining to a secret gesture associated with the trusted individual. In addition, the system includes a display, a verification officer input device, and a controller at the verification facility. The controller is coupled to the token receiver, the image receiver, the display and the database, such that the controller can receive the token and the verification image, retrieve the data record in the database associated with the received token and present at least a portion of the retrieved record on the display along with the verification image for review by a verification officer. The controller allows the verification officer to enter a verification decision using the verification officer input device. Moreover, the system includes a transmitter at the verification facility, coupled to the verification officer input device, to transmit a verification decision to the physical location where the requesting individual is present, such as to the requesting individual's computer or to a point-of-sale terminal at that physical location.

Still another aspect of the present invention is a method for authenticating the identity of an individual seeking registration as a trusted individual. The method includes receiving personal information, including the name of the individual seeking registration, receiving an image depicting the individual seeking registration, and receiving data pertaining to a secret gesture to be associated with that individual once he or she is registered as a trusted individual. The method further includes conducting an investigation based, in part, on the personal information received from the requesting individual to develop a list of persons likely to recognize the individual seeking registration from the received image depicting that individual. The received image is then displayed to at least one person from the developed list of persons. The individual seeking registration is authenticated if at least one person to whom the image of the individual seeking registration is displayed recognizes the individual depicted in the image as having the name provided by the individual seeking registration. Once his or her identity is authenticated, the individual seeking registration is registered as a trusted individual, and one or more images of that individual, including data pertaining to his or her associated secret gesture and that individual's personal information are stored in a verification database, the stored information being retrieved by use of a token assigned to that individual.

### BRIEF DESCRIPTION OF THE DRAWINGS

For a more complete understanding of the present invention, reference is made to the following detailed description of exemplary embodiments with reference to the accompanying drawings in which:

FIG. 1 is a schematic diagram illustrating a system in accordance with an exemplary embodiment of the present invention;

FIG. 2 illustrates a flow diagram of a method in accordance with an exemplary embodiment of the present invention;

FIG. 3-FIG. 5 illustrate potential image screens presented to a verification officer in accordance with the present invention;

FIG. 6 illustrates a potential screen displayed to an individual seeking registration as a trusted individual or to a requesting individual seeking verification in accordance with the present invention; and

FIG. 7 illustrates a flow diagram of a method in accordance with another exemplary embodiment of the present invention.

### DETAILED DESCRIPTION OF THE INVENTION

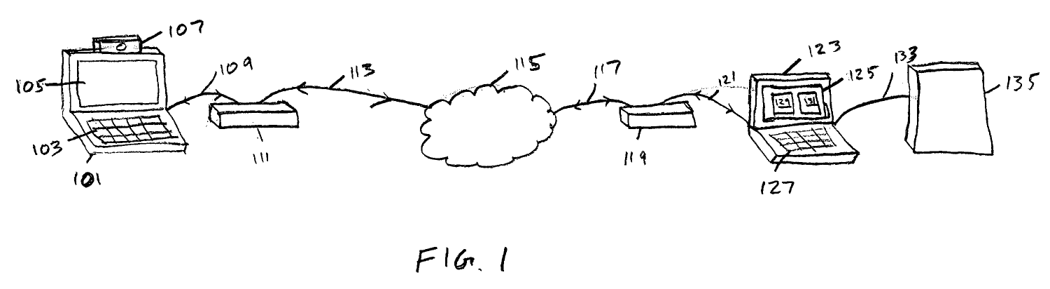

Referring to FIG. 1, there is shown a schematic diagram of a system according to an exemplary embodiment of the present invention. The system includes requesting terminal 101, which in an exemplary embodiment, may be a general purpose personal computer, Personal Digital Assistant, handheld device, such as a cellular telephone, or any other equivalent device running any suitable operating system, such as the WINDOWS® 98 or more recent version of the MICROSOFT WINDOWS® operating system, UNIX®, Linux, MAC OS®, Windows CE® or other well-known general purpose operating systems. Requesting terminal 101 may also be a specific-purpose machine, designed to function only in use with the present invention. Requesting terminal 101 includes user-input device 103, such as a keyboard and/or mouse, display 105, such as a CRT or LCD screen, and image capture device 107, such as a digital camera employing a CCD, a document scanner, or any equipment capable of capturing an image of a document for electronic storage and transmission. Requesting terminal 101 also includes a controller, such as a programmed central processing unit (CPU) and associated memory, not shown, for performing the functions called for by the present invention as described herein.

Terminal 101 is in two-way communication 109 with a network interface device (NID) 111, such as a modem, network card, or wireless network interface. NID 111 may be internal to terminal 101, or may be an external device, as shown. NID 111 may include a combination of devices, such as a network interface card for interfacing with an Ethernet network, and a cable modem or xDSL modem for interfacing the Ethernet network with another network. Alternatively, the combination of devices may allow wireless communications with a network, such as a modem and wireless transceiver. This combination of devices may be internal devices, external devices, or a combination thereof. NID 111, in turn, allows two-way communications 113 with devices connected to a computer network 115, such as the network of computer networks known as the Internet.

Also shown in FIG. 1 is verification terminal 123. Verification terminal 123 is similar to requesting terminal 101, and includes display 125, input device 127, a controller such as a programmed CPU and associated memory (not shown), and operates using any suitable operating system, as previously described, such as the MICROSOFT WINDOWS® 98 operating system. Verification terminal 123 is in two-way communication 121 with NID 119, which is similar to NID 111. NID 119, in turn, is in two-way communication 117 with devices connected to computer network 115, such as requesting terminal 101. Verification terminal 123, is capable of reading and writing data 131 to database 135. Database 135 may be stored in memory media internal to verification terminal 123, such as a hard disk drive, not shown, or may be stored in memory media external to verification terminal 123, such as a RAID, optical disks, or a Storage Area Network, not shown. Database 135, may be stored on a computer server at a location remote from the physical location of verification terminals 123; but typically database 135 will be stored on a device at or near the physical location of verification terminal 123. Verification terminal 123, is capable of displaying images 129, 131 received from requesting terminal 101 and/or database 135.

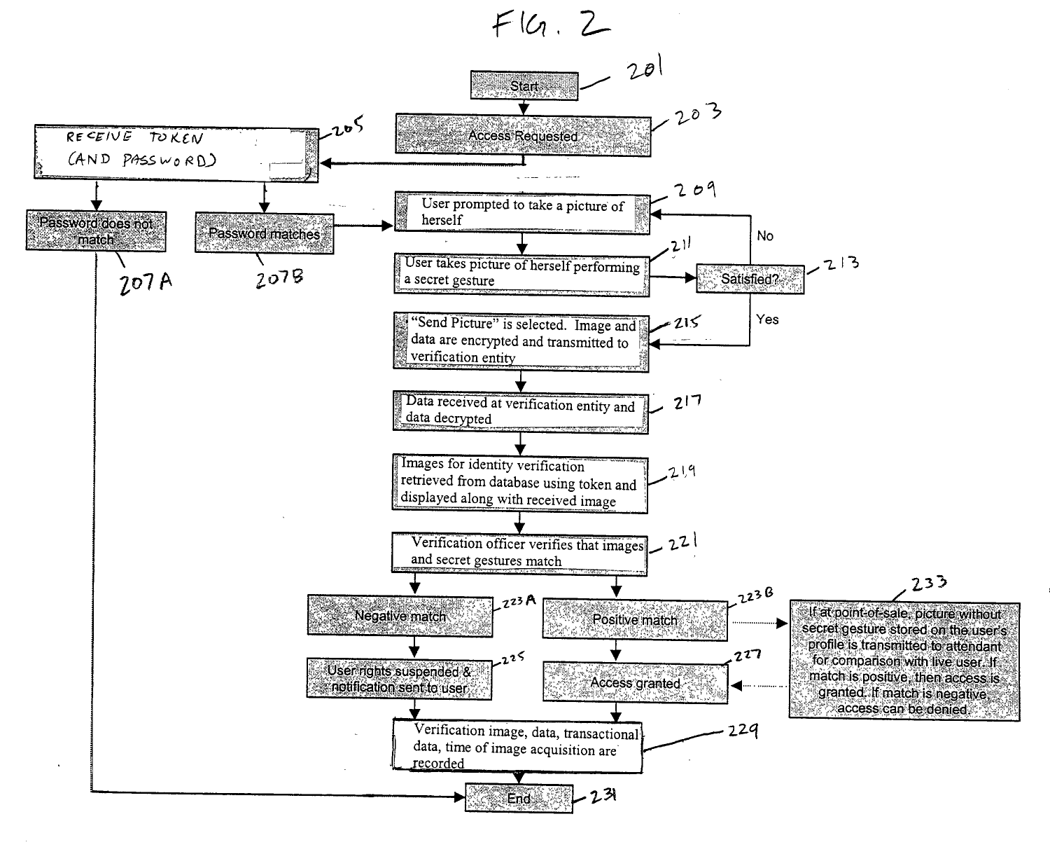

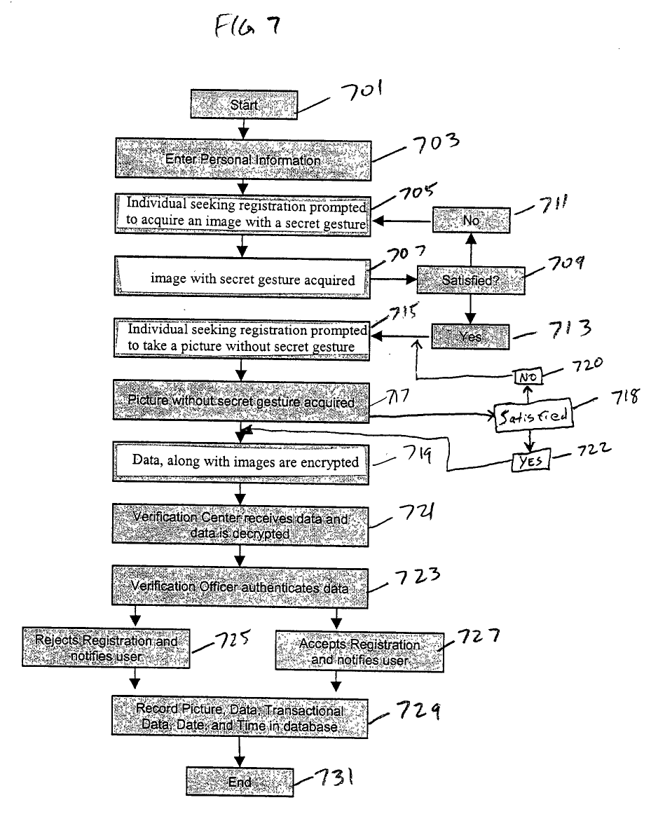

Referring now to FIG. 2, a method is illustrated for verifying the identity of a requesting individual. For convenience, feminine pronouns will be used throughout when referring to individuals involved in the operation of the present invention. It should be understood that no limitation on the scope of the invention is intended thereby. The process begins at step 201 and proceeds to step 203, where an individual requests that her identity be verified by a verification entity. This individual is referred to as the “requesting individual.” It should be noted that before an individual becomes known to the verification entity, she will typically go through an initial registration and authentication process. After her identity is authenticated, she becomes a “trusted individual,” discussed herein. An individual seeking to become registered with the verification entity, whose identity has not been authenticated, is referred to herein as a “registering individual” with respect to FIG. 7.

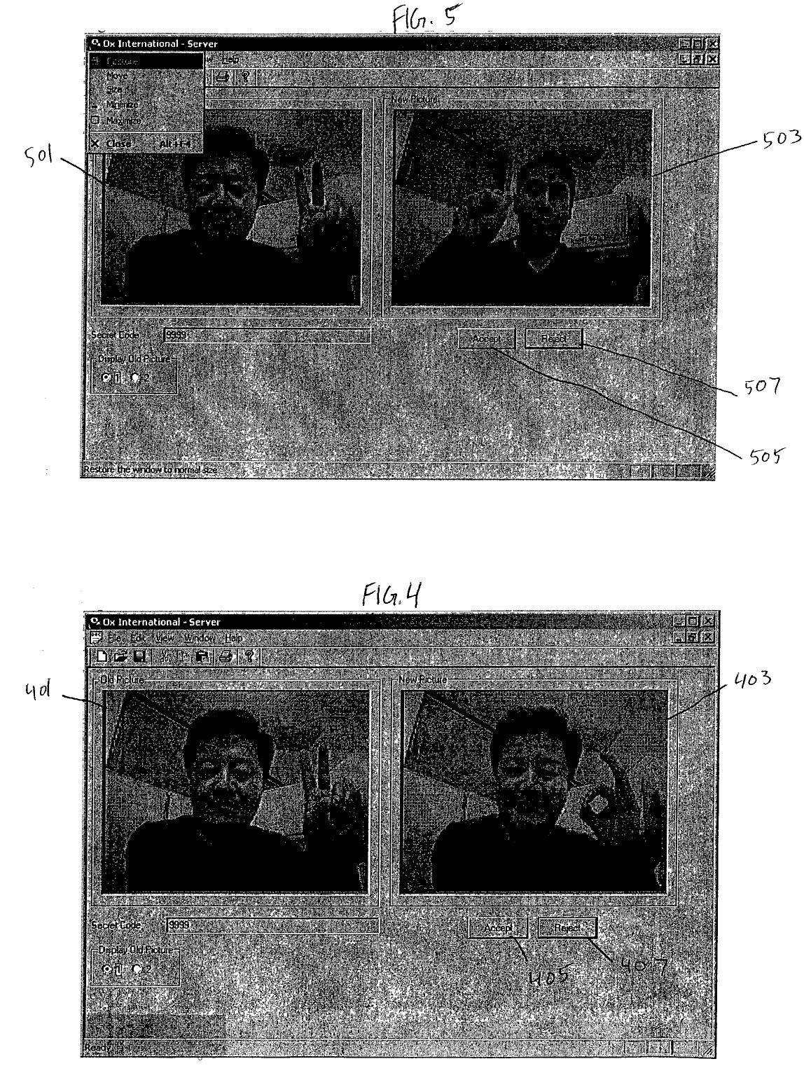

The term “verification entity” as used herein means a system, organization, person or other entity that performs the function of verifying the identity of requesting individuals. The verification entity may be the entity with whom the requesting individual seeks to transact, a third party specializing in verification, or a combination thereof. The request may be made by the requesting individual invoking a computer program residing on a computer terminal at her location. In an exemplary embodiment depicted in FIG. 6, the requesting individual initiates a verification request by clicking the “Login” button 601 with an input device, such as a computer mouse, not shown. Alternatively, the request may be initiated automatically in response to the requesting individual requesting to engage in a transaction.

The term “transaction” as used herein means any transaction or attempted access, such as the purchase of goods or services, access to data residing on a remote computer server, physical access to a secure facility or area, or any other transaction for which the identity of the requesting individual must be verified. The term includes transactions where the requesting individual is physically present at a location with the entity with whom she seeks to conduct a transaction, as well as electronic transactions, where the requesting individual is at a physical location remote from the entity with whom she seeks to conduct a transaction.

Once the verification request is made, the method proceeds to step 205 where the requesting individual is prompted to input a token that uniquely identifies the trusted individual that the requesting individual purports to be. As used herein, the term “trusted individual” means an individual that has previously registered with the verification entity by providing information to the verification entity and whose identity has been previously authenticated by the verification entity to its satisfaction. One exemplary technique for authenticating the identity of a potential trusted individual by a verification entity is discussed herein with respect to FIG. 7. If the requesting individual can establish that she is the trusted individual that she purports to be, her identity will be verified and the transaction may proceed.

As used herein, the term “token” is intended to mean any information or data that uniquely identifies the trusted individual that the requesting individual purports to be. The token may be, for example, an alpha-numeric User ID previously provided to the trusted individual. The User ID may be selected by the trusted individual during her registration with the verification entity or may be provided to the trusted individual by the verification entity. The token also may be the email address of the trusted individual, the name of the trusted individual, the social security number of the trusted individual, a credit card number, a code assigned to her, other personal information associated with the trusted individual, or a combination thereof. The token may change over time, such as after a certain time period or after each transaction, or the token may remain fixed. If the token changes over time, the new token must be communicated to the trusted individual for her use during step 205 in a subsequent verification request. In an embodiment of the present invention where the requesting individual is physically present at the same location as a local attendant (e.g. a sales clerk), such as at a point of sale transaction, the token may be input by the local attendant present at that location, rather than by the requesting individual, or the token may be automatically and/or manually extracted from a physical object, such as a card having a magnetic strip with a machine-readable code recorded thereon, a barcode with a machine readable code encoded therein, or a smart card with a code embedded therein.

In one exemplary embodiment of the present invention, during step 205, the requesting individual may optionally be required to enter a password or other information known only to the trusted individual that she purports to be. If this optional requirement is employed, the password is compared to the trusted individual's password in step 207A, 207B. If the password does not match the trusted individual's password 207A, the verification is denied and the process terminated at step 231. A record may be made of the access attempt in a database maintained by the verification entity. If the password does match the trusted individual's password 207B, or if the optional requirement of receiving a password is not utilized, the process proceeds to step 209, where the requesting individual is prompted to pose for and take a picture of herself while performing a secret gesture associated with the trusted individual. This image of the requesting individual performing the secret gesture is referred to herein as a “verification image.”

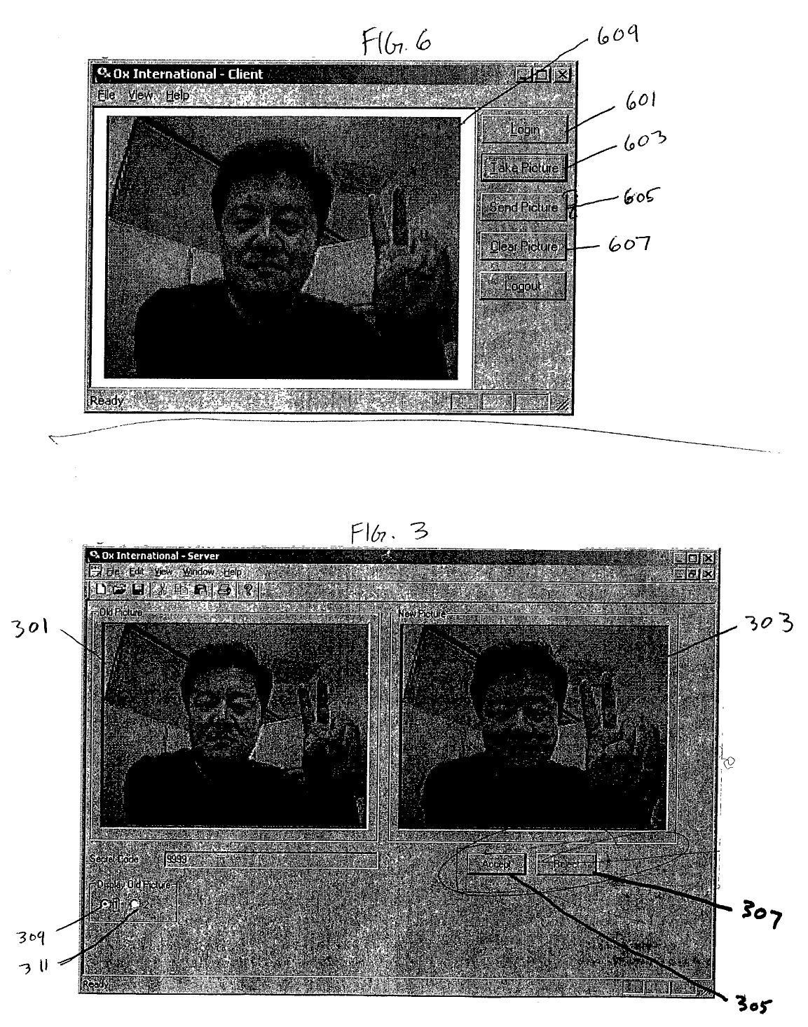

The term “secret gesture” as used herein, is intended to mean any type of information that is known only to the trusted individual and the verification entity to indicate that the integrity of the image is not compromised and to assist in verifying the identity of the individual or to signal the individual is in distress in a subsequent verification attempt. The term is intended to include any information that can be captured and integrated into an image or combination of images, or attached as additional information thereto. Examples of a secret gesture as used herein include, without limitation, a hand gesture, physical appearance, body position, facial expression, display of a specific object, presence of a particular background in an acquired image, a watermark embedded in the image, or a combination thereof. The secret gesture may include gestures requiring the capture of multiple images, or video information, such as the waving of a hand. The secret gesture may also consist entirely of audio information attached to the image or may include both an audio and visual component. Examples of audio information that may comprise the secret gesture in whole or part include the utterance of a word, phrase, group of phrases or utterance of audio information having a predetermined relationship to information in the associated visual image or images. While the term secret gesture as used herein is intended to include each of the previously described possibilities, the exemplary embodiment described herein makes use of a secret gesture visible in the verification image, such as a particular hand gesture as depicted in FIGS. 3-6. During initial registration with the verification entity, the trusted individual selects at least one secret gesture and relays that gesture to the verification entity, in a process described herein with respect to FIG. 7. When the requesting individual is prompted to pose for the verification image, she is not told what the secret gesture associated with the trusted individual is. In this way, the secret gesture serves as an important security measure to assist in verifying the identity of the requesting individual.

In one exemplary embodiment, there are at least two secret gestures associated with each trusted individual. The first secret gesture serves to verify the identity of a requesting individual, as described in more detail herein and is also referred to as a verification secret gesture. The second secret gesture is referred to as a “distress gesture” and is performed by a requesting individual during a verification session when she wants to alert a verification officer that she is not willingly attempting to perform the transaction, such as when the requesting individual is being coerced by a criminal to attempt the transaction. Upon receiving a verification image of the requesting individual performing the distress gesture, the verification officer may notify law enforcement or security personnel at the physical location of the requesting individual that the requesting individual is in distress and needs assistance. The verification entity may determine the physical location of the requesting individual using either personal information received during the individual's initial registration with the verification entity, using transactional information received during the attempted transaction, as hereinafter described, or by any other means whereby the physical location of the requesting individual may be known or approximated.

The process next proceeds to step 211 where the requesting individual poses for the verification image. In one exemplary embodiment, a digital camera is mounted on the requesting individual's computer terminal to acquire the verification image. The step of acquiring the verification image may optionally include associating a date/time stamp with the verification image that represents the time the verification image was acquired. The date/time stamp, if employed, may appear as part of the verification image, or may be stored separately as alphanumeric data. The image may be automatically acquired by the requesting individual's terminal, or the requesting individual may initiate the process of acquiring the image, such as by clicking the “Take Picture” button 603 in the interactive screen display illustrated in FIG. 6. Once the image is acquired by the digital camera, the verification image is optionally displayed to the requesting individual for approval of the image before it is transmitted to the verification entity, such as in display window 609 shown in FIG. 6. If the verification image is displayed for the requesting individual's approval, the process proceeds to step 213 where an input from the requesting individual designating their decision as to whether the image is satisfactory for transmission to the verification entity is received. A verification image will generally be satisfactory when it accurately depicts the appearance of the requesting individual and accurately depicts the requesting individual's performance of the secret gesture. If the verification image is not satisfactory to the requesting individual—which may be indicated by clicking the “Clear Picture” button 607 in the exemplary interactive screen display illustrated in FIG. 6 with a computer mouse, not shown—the process returns to step 209 where the requesting individual is again requested to pose for the verification image.

If the image is satisfactory to the requesting individual—which may be indicated in an exemplary embodiment illustrated in FIG. 6 by clicking the “Send Picture” button 605, with a computer mouse, not shown—or if the optional step of displaying the verification image to the requesting individual for her approval is not utilized, the process proceeds to step 215, where the verification image and any associated date/time stamp information is transmitted to the verification entity. Step 215 also includes transmission of the token received from the requesting individual during step 205 (not shown), if that token was not previously transmitted to the verification entity. Step 215 may further include transmitting data regarding the proposed transaction, such as the goods and/or services the requesting individual is attempting to buy or sell, the data the requesting individual is attempting to access, the current date or time, the Internet Protocol (IP) address of the computer from which the verification request originated, the location of the requesting individual, and other associated transactional data to assist in record-keeping, such as billing of a merchant and/or requesting individual making use of the verification entity's services, and in a subsequent investigation if it is later determined that the attempted transaction is fraudulent. In the exemplary embodiment illustrated, the verification image and any other data transmitted during step 215 are encrypted before they are transmitted. Encryption may be via any of the methods known to one of ordinary skill in the art such as via Secure Sockets Layer (SSL) or Transport Layer Security (TLS) using the RSA or DES encryption algorithms. Other encryption schemes could be used as long as the transmitted data, especially the verification image, is not transmitted in an unencrypted form for reception by an eavesdropper located along the communication path.

In step 217, the data transmitted by the requesting individual's terminal is received by the verification entity at a verification terminal. In the exemplary embodiment where data is encrypted for transmission during step 215, the received data is decrypted in step 217.

In step 219, previously stored data associated with the token that was input or otherwise provided by the requesting individual and received at the verification entity is retrieved from a data record stored in a database. The database of previously stored data is secure and accessible only by authorized agents of the verification entity. These authorized agents may be, for example, verification officers and/or local attendants at the physical location of the requesting individual. In the exemplary embodiment, the retrieved data includes an image that accurately depicts the appearance of the trusted individual associated with the received token as well as data pertaining to the secret gesture or gestures associated with the trusted individual. The data pertaining to the trusted individual's secret gesture may be a textual description of the trusted individual's secret gesture, or may be an image of the trusted individual performing her associated secret gesture. In the latter case, it may only be necessary to access one image of the trusted individual since that image would both accurately depict her appearance and her secret gesture. In step 219, the accessed data is displayed along with the received data, including the verification image, for a verification officer to review. As used herein, the term “verification officer” is any individual, acting alone or together with another verification officer or officers, authorized by the verification entity to determine whether the identity of the requesting individual should be verified in accordance with the principles of the invention described herein.

In step 221, the verification officer determines whether to verify the requesting individual. The decision as to whether or not to verify the requesting individual is referred to herein as a “verification decision” or “identity verification decision.” During this step, the verification officer makes two determinations: 1) whether the appearance of the requesting individual matches the appearance of the trusted individual as reflected in the previously stored image or images of the trusted individual in the database, and 2) whether the requesting individual is performing the secret gesture in the verification image that is associated with the trusted individual. Both of these determinations may be made by a single verification officer present at a verification terminal at a location remote from the physical location of the requesting individual. In that circumstance, the verification officer makes the determination based wholly on the appearance of the requesting individual depicted in the verification image. If date/time stamp information associated with the verification image is transmitted to the verification entity and displayed to the verification officer during step 221, the verification officer may use that information to ensure that she is viewing a contemporaneous image of the requesting individual. Examples of potential data that may be displayed to a verification officer during step 221 are shown in FIGS. 3-5. Alternatively, both determinations may be made by a local attendant present at the physical location of the requesting individual. In that circumstance, the local attendant makes the determination based on the appearance of the requesting individual rather than the verification image. The appearance of the requesting individual is compared to the previously stored image in the data record of the verification database that is associated with the token that the requesting individual provided. The local attendant may also observe the requesting individual while performing her associated secret gesture and compare the observed gesture with the information regarding the secret gesture that is stored in the data record of the verification database that is associated with the token that the requesting individual provided. The requesting individual may perform the secret gesture at the point of sale or may perform the secret gesture in a closed kiosk or booth where the performance of the secret gesture may be captured as a digital image by a camera and relayed to the local attendant for comparison with the secret gesture information retrieved from the verification database.

FIG. 3 illustrates a display of potential data presented to a verification officer during step 221 of the method illustrated in FIG. 2. Verification image 303 is shown displayed next to a previously stored image 301 of the trusted individual that is associated with the token input by the requesting individual in step 205 and received in step 217. The previously stored image 301 may be an image received and stored in the database at the time of the trusted user's initial registration with the verification entity, described in further detail herein, or may be a past verification image that was stored after the requesting individual was verified. Storage and use of past verification images is useful, for example, when an individual's appearance changes over time due to aging, facial hair changes, changing hairstyles, or other changes in the appearance of the trusted individual. By using these more recent images, instead of, or in addition to the original registration image, a verification officer is able to more easily and accurately verify the identity of the requesting individual. Where more than one previously stored images are available, a verification officer may compare the verification images to more than one of the previously stored images of the trusted individual by selecting different stored images, such as by selecting button 309 or button 311 in FIG. 3, where each button corresponds to a different previously stored image of the trusted individual. It will be apparent to one of ordinary skill in the art that more than two previously stored images could be made accessible to a verification officer using well-known techniques rather than the two buttons 309 and 311.

As an alternative or in addition to the use of past verification images to assist in verifying the identity of a requesting individual where the requesting individual's appearance has changed over time, a verification officer can make use of personal information relating to one or more identification documents associated with the trusted individual that is previously stored in the verification database. For example, during initial registration with the system, the trusted individual may provide data regarding an identification document, such as a driver's license, social security card, credit card, or passport. The provided data may include a image of the identification document itself such that written information appearing on the identification document is legible in the image or it may be simply some or all of the data appearing on the identification document. Accordingly, when the verification officer desires further confirmation of the identity of the requesting individual, such as when the requesting individual's appearance has changed since her previously stored registration image was acquired, the officer can require the requesting individual to provide personal information contained in the same identification document from which such information was provided and stored in the database at the time of registration of the trusted individual corresponding to the received token. For example, the verification officer may require the requesting individual to provide her driver's license number, her date of birth, her address, her eye color or other information appearing on the identification document. Alternatively, the verification officer may require the requesting individual to capture an image of their identification document such that the verification officer can compare the information depicted thereon with previously stored personal data contained in the same identification document. Rather than making a specific request for this information, the system may alternatively always require the requesting individual to provide this information, which is used by the verification officer to assist in verifying the identity of the requesting individual.

Additionally, it may be possible to require the requesting individual to provide information during her verification attempt that does not appear on the face of the identification document, but which may be determined from information appearing on the document using an information database maintained by the verification entity or by a third party. For instance, the requesting individual's driver's license number will not typically appear on the face of her social security card, but it may be possible to look up the requesting individual's driver's license number given her social security number in a database maintained by third parties, such as state drivers' license authorities. Consequently, during initial registration, the trusted individual may provide only her social security number from her social security card. That information would be then be stored in the verification entity's database. When the requesting individual presents herself for verification, the verification officer may use the previously stored social security number to determine the requesting individual's driver's license number. The requesting individual is then requested to provide her driver's license number to confirm her identity.

Given the image data shown in FIG. 3, a verification officer would verify the requesting individual since the requesting individual depicted in the verification image 303 closely resembles the trusted individual depicted in previously stored image 301, and because the requesting individual depicted in verification image 303 is performing the secret gesture associated with the trusted individual, as depicted in previously stored image 301. The verification decision could be entered by clicking the “Accept” button 305, with a computer mouse, not shown. In this situation, the process illustrated in FIG. 2 proceeds to step 223B, representing a positive identification of the requesting individual.

In FIG. 4 is shown further potential data that might be displayed to a verification officer during step 221 of FIG. 2. In this example, the verification image 403 is again displayed side-by-side with the previously stored image of the trusted individual 401 that the requesting individual purports to be. Here the verification officer would not verify the requesting individual. Although the requesting individual has the same appearance as the trusted individual, the requesting individual is not performing the secret gesture associated with the trusted individual, as depicted in previously stored image 401. The verification officer may input the verification decision by clicking the “Reject” button 407, with a computer mouse, not shown. In this situation, the process illustrated in FIG. 2 proceeds to step 223A, representing a refusal to verify the identity of the requesting individual.

In FIG. 5, yet further potential data that might be presented to a verification officer during step 221 of FIG. 2 is illustrated. Again the verification image 503 is displayed next to the previously stored image of the trusted individual 501 that the requesting individual purports to be. In this example, the verification officer would reject verification since the requesting individual depicted in the verification image 503 does not have the same appearance as the trusted individual depicted in the previously stored images 501 and because the requesting individual is not performing the secret gesture associated with the trusted individual. Again, the verification decision could be entered by the verification officer by clicking the “Reject” button 507 with a computer mouse, not shown. In this situation, the process illustrated in FIG. 2 proceeds to step 223A, representing a refusal to verify the identity of the requesting individual.

In an exemplary embodiment where the requesting individual in the verification image is performing a distress gesture instead of the verification secret gesture, step 221 includes a comparison of the verification image with the previously stored image of the trusted individual performing her associated distress gesture to determine if the requesting individual is performing the distress gesture. In this embodiment, the verification officer may make use of buttons, such as buttons 309 and 311 shown in FIG. 3, to select previously stored images of the trusted individual performing the verification secret gesture and the distress gesture. For example, button 309 may be used to retrieve a previously stored images of the trusted individual performing her associated verification secret gesture, while button 311 may be used to retrieve a previously stored image of the trusted individual performing her associated distress secret gesture, the latter image being stored at the time the trusted individual is registered.

In another exemplary embodiment, where the requesting individual is at the same physical location with a local attendant, such that the visage of the requesting individual can be observed directly by the local attendant, the verification decision of step 221 may be separated and performed by both the local attendant and the verification officer at the remote verification facility, as represented by optional step 233. This embodiment is useful where, for example, the requesting individual presents himself at a place of business and requests a transaction. In these circumstances, the local attendant present at the location of the requesting individual may be the merchant, or an employee of the merchant, with whom the requesting individual seeks to transact. A local attendant present at that location can capture a digital image of the requesting individual while performing her secret gesture. Alternatively, the local attendant at that location can ask the requesting individual to enter a kiosk or booth where she can be photographed performing her secret gesture, so that the secret gesture is not observable by anyone at that location. This may be carried out so that not even the local attendant at that physical location can witness the secret gesture. The method illustrated in FIG. 2 proceeds as previously described. The token provided by the requesting individual in step 205 may be an account number, such as that found on a traditional credit card, in lieu of the User ID previously described. In that case, the token may be entered using an electronic credit card reader in operation at the place of business. The verification image and token data are communicated in step 215 to a verification officer at a verification facility remote from the physical location of the requesting individual. The verification officer at the remote verification facility receives the data in step 219 and proceeds with viewing the verification image along with a previously stored image of the trusted individual associated with the received token. In this embodiment, the verification officer at the remote verification facility may decide only whether the requesting individual is performing the appropriate secret gesture, i.e. the secret gesture associated with the trusted individual she purports to be. The verification decision of the verification officer at the remote location as to whether the requesting individual is performing the appropriate secret gesture is then communicated back to the local attendant at the physical location of the requesting individual, corresponding with step 223B. The verification officer at the remote location may also transmit a previously stored image of the trusted individual where the trusted individual is not performing the secret gesture to the local attendant at the physical location of the requesting individual, as represented in optional step 233. The local attendant at the location of the requesting individual then compares the received previously stored image of the trusted individual with the visage of the requesting individual. If the local attendant at the location of the requesting individual determines that the requesting individual has the same appearance as the trusted individual depicted in the previously stored picture, and the verification officer at the remote verification facility determined that the requesting individual depicted in the verification image was performing the appropriate secret gesture, the requesting individual is verified and the transaction can precede, as illustrated by step 227.

In this embodiment, the secret gesture associated with the trusted individual need not be revealed to anyone other than the verification officer at the remote verification facility. Additionally, in this embodiment, the result of the remote verification officer's verification decision can be communicated to the local attendant present at the location with the requesting individual along with data indicating the reasons for the remote verification officer's decision. For example, where the remote verification officer decides not to verify the requesting individual, she may indicate the reasons for her refusal, such as, the requesting individual was not performing the correct secret gesture, or the secret gesture was not visible in the verification image. Alternatively, the remote verification officer can communicate a preliminary assessment of whether the requesting individual is the person depicted in the previously stored image of the trusted individual. The local attendant present at the physical location with the requesting individual may accept or reject the verification officer's preliminary assessment based on her own observation of the requesting individual and the previously stored image of the trusted individual that is transmitted to her from the remote verification facility.

Regardless of whether the verification decision is made by a verification officer at a remote verification facility, or a local attendant present at the location of the requesting individual, the process proceeds to step 223A or 223B based on the verification decision of the verification officer or the local attendant. If the verification decision is that the requesting individual appears to be the trusted individual and was performing the proper secret gesture, the process proceeds to step 223B. If the verification decision is that the requesting individual does not appear to be the trusted individual, or did not perform the correct secret gesture, the process proceeds to step 223A. In the exemplary embodiment where a distress gesture may be performed by the requesting individual instead of a verification secret gesture, if the verification officer determines that the requesting individual is performing the distress gesture, the process proceeds to step 223A.

Following step 223A, the process proceeds to step 225 where the trusted status of the trusted individual whom the requesting individual purported to be is suspended. While her status is suspended, the trusted individual will be prevented from being verified by the verification entity. The trusted individual may be notified of this suspension, and an investigation into the failed verification can occur to determine if the failed transaction represented an attempted fraudulent transaction. Once it is determined that the failed transaction was not fraudulent, or once appropriate steps have been taken to catch the perpetrator of the attempted fraud, the trusted status of the trusted individual can be restored. Restoring the trusted status of a trusted individual may involve altering the trusted individual's secret gesture, any associated password, or other account data. In the exemplary embodiment where the verification officer determines that the requesting individual was performing a distress gesture, step 223A may involve notifying law enforcement or other security personnel at or near the physical location of the requesting individual that the requesting individual is in distress and in need of assistance. In this scenario, rather than notifying the requesting individual that the verification attempt has failed, the verification entity may report that the verification was incomplete for some other reason such as technical difficulties or temporary unavailability of the verification system. Alternatively, the verification system may return no information at all, appearing to have been non-responsive to the verification request. In this manner, any person attempting to coerce the requesting individual into performing the transaction would not be made aware that the requesting individual had performed a distress gesture or that authorities had been alerted. The system may request the requesting individual to attempt the transaction again in a few minutes to allow law enforcement personnel time to respond to the alert sent by the verification entity. Depending on the nature of the transaction, such as where the pecuniary amount involved in the transaction is small, the system may instead allow the transaction to proceed as if the requesting individual's identity had been verified, so as to not alert the potential assailant that the requesting individual had performed the secret gesture. Moreover, it may be feasible to slow down any remaining steps in the transaction process after verification to allow law enforcement personnel time to respond to the alert sent by the verification entity. It will be apparent to one of ordinary skill in the art that numerous modifications could be made to the method and system described, depending on the purpose for which it was being used, to permit the use of the distress gesture to alert authorities of the need for immediate assistance at the physical location of the requesting individual while not tipping off any potential assailant that a distress signal had been communicated to the verification entity.

Following step 223B, the positive verification decision may be communicated to the requesting individual, a program running on the computer terminal that the trusted individual is using to perform a transaction, and/or the party with whom the requesting individual seeks to transact. The trusted individual is then granted permission to perform the requested transaction, as reflected in step 227.

Regardless of whether the requesting individual was verified, the process proceeds from either step 225 or 227 to step 229 where data associated with the verification request is recorded in a database of the verification entity. The data recorded should include the verfication image of the requesting individual as well as any associated transactional data, previously described. This data may be used to identify the perpetrator of a fraud if it is later determined that the transaction was fraudulent. The stored image and transactional data will also prevent the trusted individual from attempting to repudiate the transaction later by claiming that she did not request the transaction, as the image will be a positive record of her request. The stored verification image may also be used in subsequent transactions to assist in verifying that a requested individual is the trusted individual she purports to be, such as where the trusted individual's appearance has changed over time. Thus, as previously described, these stored verification images may become the previously stored images of the trusted individual used during step 219 of the method depicted in FIG. 2, during subsequent verification requests.

After data associated with the verification request is recorded, the process ends with step 231.

Referring now to FIG. 7, a method for authenticating the identity of an individual who wishes to be registered as a trusted individual known to a verification entity is shown. Once the identity of the individual seeking to be registered is confirmed to be the person she claims to be, she is registered by the verification entity as a “trusted individual.” The process starts at step 701 and proceeds to step 703 where personal information is provided by the requesting individual. Personal information includes at least a full name, and may include other personal information such as home address, employer name, work address, home telephone number, work telephone number, social security number, drivers license number, and date of birth. The personal information may also include, or be provided in the form of a digital image of the individual's driver's license or other identification document. Where the personal information provided by the individual seeking registration does not include her name and/or work or residence address, the personal information must include information from which her name and/or work or residence address may be derived. For example, the individual seeking registration may only provide her driver's license number as long as a trusted database is available that associates that individual's driver's license number with her name and/or address. In that circumstance, the name and/or address of the individual seeking registration are derived from the trusted database, otherwise the name and/or address of the individual seeking registration are derived directly from the entered data.

In step 705, the individual seeking registration is requested to capture a digital image of herself while performing a secret gesture. The nature of the secret gesture has been previously discussed with respect to FIG. 2. Alternatively, the individual seeking registration may be required to provide data, other than a digital image, pertaining to an associated secret gesture, such as a textual description of a secret gesture that will be associated with her during step 703. Such a description might be: “thumb of right hand extended”. This description would be stored in a database controlled by the verification entity and accessed during subsequent verification procedures as illustrated in FIG. 2. In that scenario, the process proceeds from step 703 to step 715. Where a textual description of the secret gesture is entered, the description may optionally be altered before it is stored in the database. For instance, a verification officer may translate the textual description into a standardized format used by the verification entity before the description is stored. For instance, the verification entity may assign a code, such as “0012” to the secret gesture “thumb of right hand extended” and other codes to other unique secret gestures. These unique codes would permit the amount of memory utilized for storage of secret gesture information to be identical across all registered individuals. In the exemplary embodiment where a distress gesture may be performed, as previously described, the process of prompting for and receiving data, such as an image or a textual description, pertaining to a secret gesture as depicted in steps 705-713 is performed twice, once for the verification secret gesture and once for the distress secret gesture.

The digital image depicting the individual seeking registration while performing a secret gesture is then acquired in step 707. The digital image may be captured automatically by a digital camera attached to a computer terminal at the location of the individual seeking registration, or as depicted in FIG. 6, the digital image may be captured by the digital camera at the initiative of the individual seeking registration by clicking the “Take Picture” button 603, using a computer mouse, not shown. This secret gesture serves as an additional layer of security and should remain secret, known only to the registered individual and the verification entity. Should the user be forced to request a transaction against her will in a subsequent verification procedure, as depicted in FIG. 2, she can perform a gesture different than her secret gesture to avoid having her identity verified, or, where the system provides for the recognition of a registered individual performing a secret distress gesture, the registered individual can perform the distress gesture to alert the verification officer that help is needed.

In one exemplary embodiment, the acquired image is displayed for the individual seeking registration to review and approve in step 709. This optional step allows the individual to verify that the image accurately depicts her appearance and/or accurately depicts her performing her secret gesture. The image may be displayed, such as in display area 609 illustrated in FIG. 6. If the individual seeking registration approves of the image, she may click the “Send Picture” button 605 to indicate her approval, as indicated by step 713 and the process proceeds to step 715. If optional step 709 is not performed, the process proceeds directly from step 707 to step 715.

If optional step 709 is performed and the requesting individual is not satisfied with the acquired image, she may indicate her disapproval by clicking the “Clear Picture” button 607, with a computer mouse, not shown, indicated by step 711. In that case, the process returns to step 705 where the individual is prompted to pose for a new image of herself performing her secret gesture.

Once the image of the individual seeking registration performing the secret gesture is acquired, or if data pertaining to the secret gesture is supplied in another form, such as a textual description of the secret gesture during step 703, the process proceeds to step 715 where the user is again prompted to capture a digital image of herself, this time while not performing her secret gesture. Again, the image may optionally be displayed for the individual seeking registration to approve or retake as in steps 718, 720 and 722 before it is transmitted to the verification entity. During step 717, the individual seeking registration may optionally be required to capture a digital image of herself while displaying an identification card, such as a driver's license or passport. This image may be in addition to, or in lieu of the image depicting the individual seeking registration while not performing a secret gesture. Such an image will assist in authenticating the identity of the requesting individual.

Once the images are acquired, the process proceeds to step 719 where the images and personal information are encrypted and transmitted to a verification entity. This data is received and decrypted by the verification entity in step 721.

The process then proceeds to step 723 where personnel at the verification entity authenticates the received data. This step may include conducting an investigation based, at least in part, on the personal data provided by the user during step 703 to develop a list of persons likely to recognize the person depicted in the image acquired in step 717. Such a list may be generated by identifying the requesting individual's employer, family members, neighbors, coworkers and/or acquaintances whose names may have previously been provided by the individual seeking registration, using reverse address lookup databases such as those available on the Internet at http://www.whitepages.com or http://www.infospace.com or using other commercial database providers, to locate persons living or working near the place of work or residence of the individual seeking registration. Persons may also be identified through local investigators associated with the verification entity who can make inquiries of persons in the neighborhood surrounding the home or place of work of the individual seeking registration looking for persons likely to recognize the individual seeking registration. Persons on the list generated in this fashion are then contacted to determine if they recognize the image of the individual seeking registration. The image acquired during step 717 and received by the verification entity in step 721 may be provided to the persons contacted for their visual identification. The images may be provided in person, by mail, or may be electronically transmitted such as by e-mail or facsimile. If one or more persons contacted in this fashion recognize the person depicted in the image to have the name and/or to work or reside at the addresses included in or derived from the personal information provided by the individual seeking registration, the individual may be authenticated and registered as a trusted individual.

In addition to, or in lieu of generating a list of persons likely to know the individual seeking registration, the investigation may make use of a trusted database that contains an image depicting the individual seeking registration. For example, use may be made of a database maintained by a governmental entity, such as a state drivers' license authority, that has images of individuals who are registered or licensed by that entity. In that case, the image of the licensed individual contained in the trusted database can be compared to the image provided by the individual seeking registration to determine if the individual is who she claims to be.

Once the investigation is complete, the verification entity determines whether to authenticate the individual registration or not. If the verification entity decides to authenticate the individual seeking registration, for example because one or more persons recognized the individual depicted in the image acquired in step 717 as being the person she purports to be, the verification entity accepts the individual seeking registration as a trusted individual, as depicted in step 727. This approval decision is then communicated to the trusted individual, along with any confirmatory information. This communication may be sent to the computer terminal of the trusted individual in encrypted form or sent via mail if the communication contains sensitive information.

Alternatively, if the verification officer is unable to authenticate the individual seeking registration, the individual is rejected and does not become registered a trusted individual, as depicted in step 725. This decision may also be communicated to the rejected individual along with any related information, such as the reasons for the rejection.

Regardless of whether the individual seeking registration becomes registered as a trusted individual, the process proceeds to step 729 where the data received by the verification entity during step 721 may be stored in a database maintained by the verification entity. This data can be used to identify subsequent perpetrators of fraud, or be used in subsequent verification procedures, such as the method depicted in FIG. 2. A person registered by the verification entity is also provided with a token to be used when requesting verification. Following step 729, the authentication method ends at step 731.

It will be understood that where there are numerous trusted individuals recognized by the verification entity, it is not necessary to perform the authentication method depicted in FIG. 7 for all individuals seeking to register with the verification entity. Instead, the investigation process described with respect to step 723 may be performed only for some small percentage of individuals seeking registration, which may be selected randomly. In this fashion, the possibility of such an investigation would deter potential perpetrators of a fraud from attempting to register with the verification entity.

Although the present invention has been described in detail with reference to exemplary embodiments thereof, it should be understood that various changes, substitutions and alterations can be made hereto without departing from the scope or spirit of the invention, the scope being defined by the appended claims. For instance, biometric facial identification software could be employed to assist the verification officer perform the tasks of verifying the identity of the requesting individual, discussed with reference to step 221 of FIG. 2. Alternatively, other biometric data could be acquired during registration with the verification entity and stored in the verification database for use in a subsequent verification request. It will also be apparent that the present has applications in numerous areas where identity verification is useful or necessary before activity is permitted, such as at places of voting, airports, access to sensitive data, such as health records, and check cashing. Numerous other applications will be apparent to one of ordinary skill in the art.

What is claimed is:

1. A method for verifying the identity of a requesting individual, comprising:
a) receiving at least one token constituting a unique identifier associated with a trusted individual that said requesting individual purports to be;
b) receiving a verification image depicting said requesting individual performing a secret gesture;
c) retrieving from a database at least a portion of a previously stored data record associated with said at least one token received in step a), said at least a portion of said previously stored data record comprising at least one previously stored image depicting said trusted individual and data pertaining to at least one secret gesture associated with said trusted individual; and
d) verifying said requesting individual is said trusted individual if:
said requesting individual depicted in said verification image is performing a particular one of said at least one secret gesture associated with said trusted individual, and
said requesting individual resembles the individual depicted in said at least one previously stored image of said trusted individual.

2. The method of claim 1, wherein the requesting individual is allowed to complete a transaction if, and only if, the result of said verifying step d) is that said requesting individual is verified as said trusted individual.

3. The method of claim 1, wherein said at least one secret gesture associated with said trusted individual comprises at least two secret gestures associated with said trusted individual, a first secret gesture constituting a verification secret gesture and a second secret gesture constituting a distress secret gesture.

4. The method of claim 3, wherein said verifying step (d) comprises verifying said requesting individual if said requesting individual depicted in said verification image is performing said first secret gesture, but not verifying said requesting individual if said requesting individual depicted in said verification image is performing said second secret gesture.

5. The method of claim 1, wherein said previously stored data record includes at least two previously stored images depicting said trusted individual, a first of said previously stored images depicting said trusted individual performing a secret gesture associated with said individual and a second of said previously stored images depicting said trusted individual not performing said secret gesture, and wherein said data pertaining to at least one secret gesture associated with said trusted individual comprises at least said first image.

6. The method of claim 5, wherein said verifying step d) comprises comparing said verfication image with said first image to determine if said requesting individual depicted in said verification image is performing one of said at least one secret gesture associated with said trusted individual and comparing said verification image with at least one image selected from the group consisting of said first and second images to determine if said requesting individual depicted in said verification image resembles the individual depicted in said selected image.

7. The method of claim 5, wherein said verifying step d) comprises comparing said verification image with said first image to determine if said requesting individual is performing one of said at least one secret gesture associated with said trusted individual and comparing the visage of said requesting individual with the visage of the individual depicted in at least one image selected from the group consisting of said first and second images to determine if the visage of said requesting individual resembles the visage of the individual depicted in said at least one selected image.

8. The method of claim 7, wherein said comparing said verification image with said first image takes place at a location remote from the physical location of said requesting individual and said comparing the visage of said requesting individual with the visage of the individual depicted in at least one image selected from the group consisting of said first and second images takes place at the physical location of said requesting individual.

9. The method of claim 7, wherein said verifying step d) comprises transmitting verification information to a local attendant at the physical location of said requesting individual, said information comprising at least the result of said comparing said verification image with said first image.

10. The method of claim 9, wherein said verification information further comprises at least indicia of the reasons for said result of said comparing said verification image with said first image.

11. The method of claim 1, further comprising:
e) storing in said database said verification image received in step b), in said data record associated with said token received in step a).

12. The method of claim 11, wherein said at least one previously stored image retrieved in step c) comprises a verification image stored in step (e) of a previous verification request.

13. The method of claim 1, further comprising:
e) storing in said database said verification image received in step b) in said data record associated with said at least one token received in step a), if the result of said verification step d) is that said requesting individual is not verified; and
f) retrieving from said database said verification image stored in step e) to subsequently identify said requesting individual as someone who has attempted to misrepresent his or her identity.

14. The method of claim 1, further comprising:
e) receiving information regarding a proposed transaction for which the identity of said requesting individual must be verified; and
f) storing in said database said information received is step e) in said data record associated with said at least one token received in step a).

15. The method of claim 1, further comprising:
e) receiving date and time information indicative of when said verification image was transmitted.

16. The method of claim 1, further comprising:
e) suspending further identity verification using the data record associated with said at least one token received during in step a), if the result of said verification step d) is that said requesting individual is not verified.

17. The method of claim 1 wherein said previously stored data record further comprises personal data relating to an identification document associated with said trusted individual and further comprising:
e) receiving further data from said requesting individual corresponding to said previously stored personal data relating to said identification document,
wherein said further data received in step e) is compared in step d), in conjunction with said previously stored personal data to determine whether said requesting individual is the individual depicted in said at least one previously stored image of said trusted individual.

18. The method of claim 1, wherein said at least one previously stored data image depicts said trusted individual performing one of said at least one secret gesture associated with said trusted individual and wherein said data pertaining to at least one secret gesture associated with said trusted individual comprises said at least one previously stored data image.

19. A method for verifying the identity of a requesting individual present at a physical location, comprising:
a) receiving at least one token constituting a unique identifier associated with a trusted individual that said requesting individual purports to be;
b) receiving a verification image depicting said requesting individual performing a secret gesture;
c) retrieving from a database at least a portion of a previously stored data record associated with said at least one token received in step a), said at least a portion of said previously stored data record comprising at least one previously stored image depicting said trusted individual and data pertaining to at least two secret gestures associated with said trusted individual, said at least two secret gestures comprising a first secret gesture constituting a verification secret gesture and a second secret gesture constituting a distress secret gesture; and
d) alerting assistance personnel to respond to the physical location of said requesting individual if said requesting individual depicted in said verification image is performing said second secret gesture.

20. A method for verifying the identity of a requesting individual, comprising:
a) prompting said requesting individual to provide at least one token constituting a unique identifier associated with a trusted individual that said requesting individual purports to be;
b) prompting said requesting individual to pose for a verification image depicting said requesting individual performing a secret gesture;
c) capturing said verification image;
d) transmitting said at least one token and said verification image to a remote verification facility;
e) receiving from said remote verification facility an identity verification decision reflecting a determination as to whether said requesting individual is said trusted individual; and
f) providing said identity verification decision to said requesting individual.

21. A method for verifying the identity of a requesting individual, comprising:
a) prompting said requesting individual to provide at least one token constituting a unique identifier associated with a trusted individual that said requesting individual purports to be;
b) prompting said requesting individual to pose for a verification image depicting said requesting individual performing a secret gesture;
c) capturing said verification image;
d) displaying said verification image captured in step c) to said requesting individual;
e) repeating steps b) through d) if said requesting individual indicates dissatisfaction with the verification image displayed in step d);
f) transmitting said at least one token and said verification image to said remote verification facility if said requesting individual indicates satisfaction with the verification image displayed in step d);
g) receiving from said remote verification facility an identity verification decision reflecting a determination as to whether said requesting individual is said trusted individual; and
h) providing said identity verification decision to said requesting individual.

22. A system for verifying the identity of a requesting individual who is physically present at a requesting location, comprising:
a token receiver at a remote verification facility for receiving at least one token constituting a unique identifier associated with a trusted individual that said requesting individual purports to be;
an image receiver at the verification facility or receiving a verification image depicting said requesting individual performing a secret gesture;
a database accessible from the verification facility containing a data record associated with said received at least one token, wherein said data record includes at least one previously stored image depicting said trusted individual and said data record further includes data pertaining to at least one secret gesture associated with said trusted individual;
a display at the verification facility;
a verification officer input device at the verification facility for receiving a verification decision;
a controller at the verification facility coupled to said token receiver, said image receiver, said display and said database, wherein said controller is capable of retrieving from said database said data record associated with said received token and presenting said data pertaining to at least one secret gesture associated with said trusted individual together with said verification image to said display and prompting a verification officer monitoring said display to input said verification decision using said verification officer input device; and
a transmitter, coupled to said verification officer input device, for transmitting said verification decision to said requesting location.

23. A system for verifying the identity of a requesting individual who is physically present at a requesting location in view of a local attendant, comprising:
a token receiver at the requesting location for receiving at least one token constituting a unique identifier associated with a trusted individual that said requesting individual purports to be;
a database accessible from the requesting location containing a data record associated with said received at least one token, wherein said data record includes at least one previously stored image depicting said trusted individual and said data record further includes data pertaining to at least one secret gesture associated with said trusted individual;
a display at the verification facility; and
a controller coupled to said token receiver, said display and said database, wherein said controller is capable of retrieving from said database said data record associated with said received token and presenting said data pertaining to at least one secret gesture associated with said trusted individual together with said previously stored image to said display for review by said local attendant.

24. A method for authenticating the identity of an individual seeking registration as a trusted individual, comprising:
a) receiving personal information pertaining to said individual seeking registration, including at least information from which the name of said individual seeking registration may be derived;
b) deriving the name of said individual seeking registration from said personal information;
c) receiving an image depicting said individual seeking registration;
d) receiving data pertaining to at least one secret gesture associated with said individual seeking registration;
e) conducting an investigation based, in part, on said personal information received in step a) to develop a list of persons likely to recognize the person depicted in said image received in step c);
f) providing said image depicting said individual seeking registration received in step c) to at least one person in said list of persons developed in step e); and
g) authenticating the identity of said individual seeking registration as a newly registered trusted individual if at least one of said at least one person provided with said image depicting said individual seeking registration in step f) recognizes said depicted individual seeking registration as having the name derived in step b).

25. The method of claim 24, wherein said personal information comprises an image of a valid identification document associated with said individual seeking registration.

26. The method of claim 25, wherein said image of a valid identification document comprises an image depicting said individual seeking registration while displaying said valid identification document.

27. A method for authenticating the identity of an individual seeking registration as a trusted individual, comprising:
a) receiving personal information pertaining to said individual seeking registration, including at least information from which the address of the individual seeking registration may be derived;
b) deriving the address of the individual seeking registration from said personal information;
c) receiving an image depicting said individual seeking registration;
d) receiving data pertaining to at least one secret gesture associated with said individual seeking registration;
e) conducting an investigation based, at least in part, on said personal information received in step a) to develop a list of persons likely to recognize the person depicted in said image received in step c);
f) providing said image depicting said individual seeking registration received in step c) to at least one person in said list of persons developed in step e); and
g) authenticating the identity of said individual seeking registration as a newly registered trusted individual if at least one of said at least one person provided with said image depicting said individual seeking registration in step f) recognizes said depicted individual seeking registration as being associated with the address derived in step b).

28. The method of claim 27, wherein said personal information comprises an image of a valid identification document associated with said individual seeking registration.

29. The method of claim 28, wherein said image of a valid identification document comprises an image depicting said individual seeking registration while displaying said valid identification document.

30. A method for authenticating the identity of an individual seeking registration as a trusted individual and for verifying the identity of a requesting individual purporting to be a trusted individual, comprising:
a) receiving personal information pertaining to said individual seeking registration, including at least information from which the name of said individual seeking registration may be derived;
b) deriving the name of said individual seeking registration from said personal information;
c) receiving at least one image depicting said individual seeking registration;
d) conducting an investigation based, at least in part, on said personal information received in step a) to develop a list of persons likely to recognize the individual depicted in said image received in step c);
e) providing said at least one image depicting said individual seeking registration received in step c) to at least one person in said list of persons developed in step d);
f) authenticating the identity of said individual seeking registration so as to cause said individual to become newly registered as a trusted individual if at least one of said at least one person provided with said image depicting said individual seeking registration in step e) recognizes said depicted individual seeking registration as having the name derived in step b),
g) creating in a database a new data record associated with any said newly registered trusted individual, said data record comprising:
a token constituting a unique identifier associated with said newly registered trusted individual,
at least a portion of said personal information received in step a), and
said at least one image received in step c);
h) receiving, subsequent to said step g), at least one token associated with a data record in said database corresponding to a trusted individual that said requesting individual purports to be;
i) receiving a verification image depicting said requesting individual;
j) retrieving from said database at least a portion of said data record associated with said at least one token received in step h), said at least a portion of said data record comprising at least one previously stored image depicting said trusted individual corresponding to said data record associated with said at least one token received in step h); and
k) verifying said requesting individual is said trusted individual if said requesting individual depicted in said verification image resembles the individual depicted in said at least one previously stored image of said trusted individual.

31. A method for authenticating the identity of an individual seeking registration as a trusted individual and for verifying the identity of a requesting individual purporting to be a trusted individual, comprising:
a) receiving personal information pertaining to said individual seeking registration, including at least information from which the address of said individual seeking registration may be derived;
b) deriving the address of said individual seeking registration from said personal information;
c) receiving at least one image depicting said individual seeking registration;
d) conducting an investigation based, at least in part, on said personal information received in step a) to develop a list of persons likely to recognize the individual depicted in said image received in step c);
e) providing said at least one image depicting said individual seeking registration received in step b) to at least one person in said list of persons developed in step d);
f) authenticating the identity of said individual seeking registration so as to cause said individual to become newly registered as a trusted individual if at least one of said at least one person provided with said image depicting said individual seeking registration in step e) recognizes said depicted individual seeking registration as being associated with said address derived in step b);
g) creating in a database a new data record associated with any said newly registered trusted individual, said data record comprising:
a token constituting a unique identifier associated with said newly registered trusted individual,
at least a portion of said personal information received in step a), and said at least one image received in step c);
h) receiving, subsequent to said step g), at least one token associated with a data record in said database corresponding to a trusted individual that said requesting individual purports to be;
i) receiving a verification image depicting said requesting individual;
j) retrieving from said database at least a portion of said data record associated with said at least one token received in step g), said at least a portion of said data record comprising at least one previously stored image depicting said trusted individual corresponding to said data record associated with said at least one token received in step h); and
k) verifying said requesting individual is said trusted individual if said requesting individual depicted in said verification image resembles the individual depicted in said at least one previously stored image of said trusted individual.

32. A method for authenticating the identity of an individual seeking registration as a trusted individual and for verifying the identity of a requesting individual purporting to be a trusted individual, comprising:
a) receiving personal information pertaining to said individual seeking registration, including at least information from which the name of said individual seeking registration may be derived;
b) receiving at least one image depicting said individual seeking registration;
c) retrieving from a trusted database at least one previously stored image of said individual seeking registration based on at least a portion of said personal information received in step a);
d) authenticating the identity of said individual seeking registration so as to cause said individual to become newly registered as a trusted individual if said individual depicted in said image received in step b) resembles said individual depicted in said image retrieved in step c);
e) creating in a verification database a new data record associated with any said newly registered trusted individual, said data record comprising:
a token constituting a unique identifier associated with said newly registered trusted individual,
at least a portion of said personal information received in step a), and
said at least one image received in step b);
f) receiving, subsequent to said step e), at least one token associated with a data record in said verification database corresponding to a trusted individual that said requesting individual purports to be;
g) receiving a verification image depicting said requesting individual;
h) retrieving from said verification database at least a portion of said data record associated with said at least one token received in step f), said at least a portion of said data record comprising at least one previously stored image depicting said trusted individual corresponding to said data record associated with said at least one token received in step f); and
i) verifying said requesting individual is said trusted individual if said requesting individual depicted in said verification image resembles the individual depicted in said at least one previously stored image of said trusted individual.

33. A method for populating a verification database for use in verifying the identity of a requesting individual purporting to be a trusted individual, comprising:
a) receiving personal information pertaining to each of a plurality of individuals seeking registration as trusted individuals including, including at least information from which the name of each of the plurality of individuals seeking registration may be derived;
b) deriving the name of each of said plurality of individuals seeking registration from said personal information;
c) receiving a respective image depicting each of said plurality of individuals seeking registration;
d) conducting an investigation, for at least one of said plurality of individuals seeking registration, based, at least in part, on said personal information received in step a) to develop a list of persons likely to recognize each of said at least one of said plurality of individuals depicted in respective ones of said images received in step c);
e) providing said image, for each of said at least one of said plurality of individuals seeking registration for which an investigation is conducted, to at least one person in said list of persons developed in step d);
f) registering as a newly registered trusted individual each of said at least one of said plurality of individuals seeking registration for which an investigation is conducted, if at least one of said at least one person provided with said image depicting said individual seeking registration in step e) recognizes said depicted individual seeking registration as having the name derived in step b), and registering as a newly registered trusted individual each of said at least one individual seeking registration for which an investigation is not conducted;
g) creating in a verification database a respective data record associated with each of said newly registered trusted individuals, comprising:
a token constituting a unique identifier associated with said newly registered trusted individual,
at least a portion of said personal information received in step a), and
said at least one image received in step c).

34. A method for populating a verification database for use in verifying the identity of a requesting individual purporting to be a trusted individual, comprising:
a) receiving personal information pertaining to each of a plurality of individuals seeking registration as a trusted individual, including at least information from which the address of each of said plurality of individuals seeking registration may be derived;
b) deriving the address of each of said plurality of individuals seeking registration from said personal information;
c) receiving a respective image depicting each of said plurality of requesting individuals;
d) conducting an investigation, for at least one of said plurality of individuals seeking registration, based, at least in part, on said personal information received in step a) to develop a list of persons likely to recognize each of said at least one of said plurality of individuals seeking registration depicted in said images received in step c);
e) providing said image, for each of said at least one of said plurality of individuals seeking registration for which an investigation is conducted, to at least one person in said list of persons developed in step d);
f) registering as a newly registered trusted individual each of said at least one of said plurality of individuals seeking registration for which an investigation is conducted, if at least one of said at least one person provided with said image depicting said individual seeking registration in step e) recognizes said depicted individual seeking registration as being associated with said address derived in step b), and registering as a newly registered trusted individual each of said at least one individual seeking registration for which an investigation is not conducted; and
g) creating in a verification database a respective data record associated with each of said newly registered trusted individuals, comprising:
a token constituting a unique identifier associated with said newly registered trusted individual,
at least a portion of said personal information received in step a), and
said at least one image received in step c).
